(19) United States
(12) Patent Application Publication
(10) Pub. No.: US 2013/0084810 A1
(43) Pub. Date: Apr. 4, 2013

(54) RECEIVING APPARATUS, BASE STATION APPARATUS AND METHOD FOR REDUCING INTERFERENCE WAVE

(71) Applicants: Satoshi Matsubara, Kawasaki (JP); Hideyuki Kannari, Yokohama (JP); Masanori Hara, Yokohama (JP); Hideharu Shako, Yokohama (JP)

(72) Inventors: Satoshi Matsubara, Kawasaki (JP); Hideyuki Kannari, Yokohama (JP); Masanori Hara, Yokohama (JP); Hideharu Shako, Yokohama (JP)

(73) Assignee: FUJITSU LIMITED, Kawasaki-shi (JP)

(21) Appl. No.: 13/561,276

(22) Filed: Jul. 30, 2012

(30) Foreign Application Priority Data
Sep. 29, 2011 (JP) 2011-214637

(51) Int. Cl. H04B 1/10; H04W 88/08

(52) U.S. Cl. 455/73; 455/234.1

(57) ABSTRACT

A receiving apparatus includes: an interference wave reducer configured to reduce an interference wave included in a received signal; and an automatic gain controller configured to automatically control a gain for the received signal, the automatic gain controller including a convergence time saver to save convergence time of an automatic gain control for the received signal based on an input of an interference wave.

### CROSS-REFERENCE TO RELATED APPLICATION(S)

This application is based upon and claims the benefit of priority of the prior Japanese Patent Application No. 2011-214637, filed on Sep. 29, 2011, the entire contents of which are incorporated herein by reference.

### FIELD

The embodiment discussed herein is related to reduction of an interference wave included in a received signal.

### BACKGROUND

In wireless communication, a gain for a received signal is automatically controlled in order that an interference wave included in the received signal is detected and reduced or that a power strength or average amplitude value falls within a specific range.

Related art is discussed in Japanese Laid-open Patent Publications Nos. 2003-283277, 2004-304568, 11-298348, and 2009-284156.

### SUMMARY

According to one aspect of the embodiments, a receiving apparatus includes: an interference wave reducer configured to reduce an interference wave included in a received signal; and an automatic gain controller configured to automatically control a gain for the received signal, the automatic gain controller including a convergence time saver to save convergence time of an automatic gain control for the received signal based on an input of an interference wave.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 depicts an exemplary power of a received signal;

FIG. 2 depicts an exemplary receiving apparatus;

FIG. 3 depicts an exemplary digital signal circuit;

FIG. 4 depicts an exemplary a received signal;

FIG. 5 depicts an exemplary process of a receiving apparatus;

FIG. 6 depicts an exemplary digital signal circuit;

FIG. 7 depicts an exemplary process of a receiving apparatus;

FIG. 8 depicts an exemplary digital signal circuit;

FIG. 9 depicts an exemplary power of a received signal;

FIG. 10 depicts an exemplary process of a receiving apparatus;

FIG. 11 depicts an exemplary process of a receiving apparatus;

FIG. 12 depicts an exemplary base station apparatus; and

FIG. 13 depicts an exemplary base station apparatus.

### DESCRIPTION OF EMBODIMENT

When a receiver gain of a radio apparatus is automatically controlled based on a difference between a received power level and a preset value, a moving averaging process may be applied to the received power level.

A receiving circuit may include an element which decides a time constant in an IC. The receiving circuit may include a comparator, which compares an output signal voltage of a frequency converting circuit with a certain voltage so as to output a comparison result, and an automatic gain amplifier circuit, which outputs first and second control signals for controlling gains of first and second variable gain amplifiers, respectively, based on the comparison result and an output signal from a demodulating circuit.

A receiving apparatus may include a mixer circuit, which mixes a local oscillation signal with a radio frequency signal so as to convert the radio frequency signal into an intermediate frequency signal, and an intermediate frequency amplifier circuit, which receives an output of the mixer circuit. The receiving apparatus may include a detector, which detects a signal level in an entire receiving frequency band where an undesired wave is included on a signal line preceding the mixer circuit, a deciding unit, which decides whether an undesired wave whose amplitude is larger than that of a desired signal is present based on an output of the detector and an output according to a received field strength of a desired wave, and a changing unit which changes linearity of a circuit based on an output of the deciding unit.

The receiving apparatus receives, by means of an antenna, a wave transmitted by a transmitter, which encodes data to be transmitted by using an error correction code and performs OFDM modulation on a string of bits to be transmitted, which is generated by reordering using a interleave, on a symbol-by-symbol basis of a certain bit length and transmits the bit string by radio, so as to restore transmitted data. The receiving apparatus includes a demodulating unit which demodulates an OFDM signal corresponding to the bit string from a signal received by the antenna, a decoding unit which performs a soft decision on a demodulated signal, de-interleaves the demodulated signal and performs error correction decoding based on a soft decision value obtained by the soft decision so as to restore the transmitted data, a variance calculating unit which calculates a variance of a signal on a symbol-by-symbol basis of the demodulated OFDM signal, and an interference detecting unit which detects that an interference wave is overlaid with a wave being received by the antenna when a variance calculated by the variance calculating unit is equal to or larger than a preset threshold.

When a signal received by a receiving apparatus having an interference reducing function and an automatic gain control function is mixed with a strong interference wave, convergence of an action to reduce the interference wave may be delayed. For example, as the automatic gain control function temporarily reduces the gain because of the mixture of the strong interference wave, convergence of an action to reduce the interference wave may be delayed due to the gain recovers.

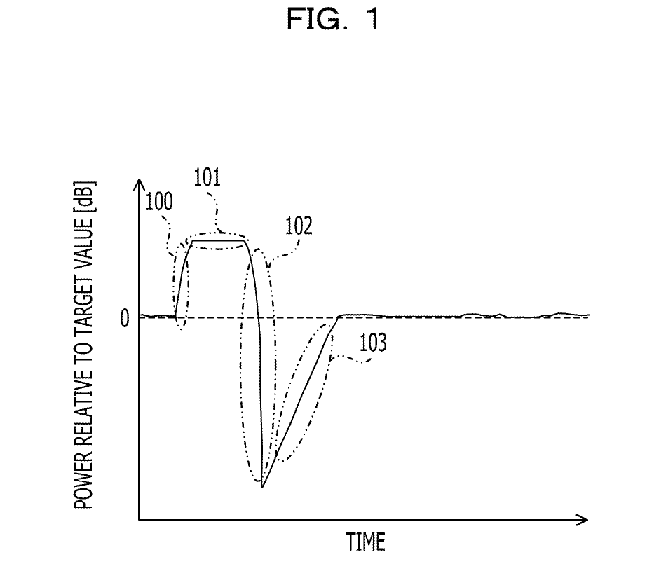

FIG. 1 depicts an exemplary power of a received signal. FIG. 1 indicates a change of power of a received signal for which a gain is adjusted by the automatic gain control. The graph has a vertical axis representing power relative to a target value of the automatic gain control. A strong interference wave is mixed in a period of time 100 resulting in that the power of the received signal abruptly increases. The automatic gain control is started and the gain for the received signal is gradually reduced. The gain of the received signal is reduced in a period of time 101. The interference wave is detected by the interference reducing function in the period of time 101. As the interference wave starts to be reduced by means of the interference reducing function and the gain for the received signal is reduced, the waveform is clipped based on an upper output limit of the automatic gain control.

As the reduction of the interference wave continues, the power of the received signal decreases in a period of time 102. As the gain of the received signal is significantly reduced in the period of time 101, the power after the gain adjustment is much lower than the target value in the period of time 102. As an action to readjust the gain after the interference wave is reduced is raised in a period of time 103, convergence of the action to reduce the interference wave may be delayed.

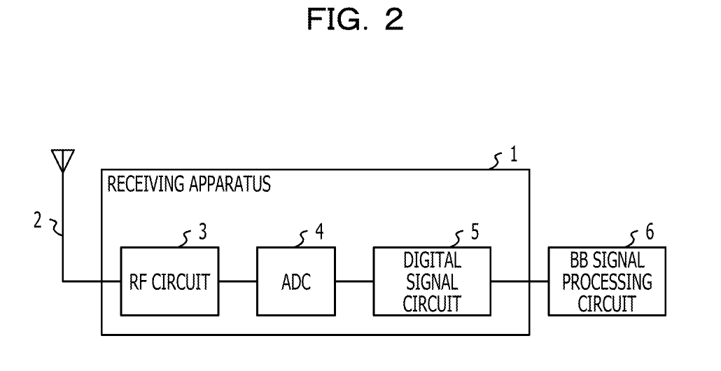

FIG. 2 depicts an exemplary receiving apparatus. FIG. 2 may depict a hardware constitution of the receiving apparatus. The receiving apparatus 1 includes an antenna 2, a radio frequency circuit 3, an analog-to-digital converter 4 and a digital signal circuit 5. The analog-to-digital converter and analog-to-digital conversion may be indicated as “ADC” and “AD conversion”, respectively, in the drawings. The radio and baseband frequencies may be indicated as “RF” and “BB”, respectively.

The radio frequency circuit 3 converts a signal of a radio frequency received by the antenna 2 into an intermediate frequency signal. The analog-to-digital converter 4 converts the intermediate frequency signal into a digital signal. The digital signal circuit 5 performs signal processing such as filtering, reducing in-band interference, automatic gain control, etc., on the digital signal, and outputs the processed digital signal to a baseband signal processing circuit 6. The digital signal circuit 5 may include a logic circuit for processing the digital signal such as an LSI (large scale integration), an ASIC (Application Specific Integrated Circuit), an FPGA (Field-Programming Gate Array), etc. The digital signal circuit 5 may include a central processing unit (CPU) and/or a digital signal processor (DSP) for processing a digital signal by software and a memory in which a program is to be stored.

The baseband signal processing circuit 6 demodulates and decodes the digital signal provided by the digital signal circuit 5. The receiving apparatus 1 may include the baseband signal processing circuit 6. The receiving apparatus 1 may be provided separately from a communication apparatus including the baseband signal processing circuit 6, and the digital signal circuit 5 may include an interface circuit for transmitting a baseband signal processed by the digital signal circuit 5 to the baseband signal processing circuit 6.

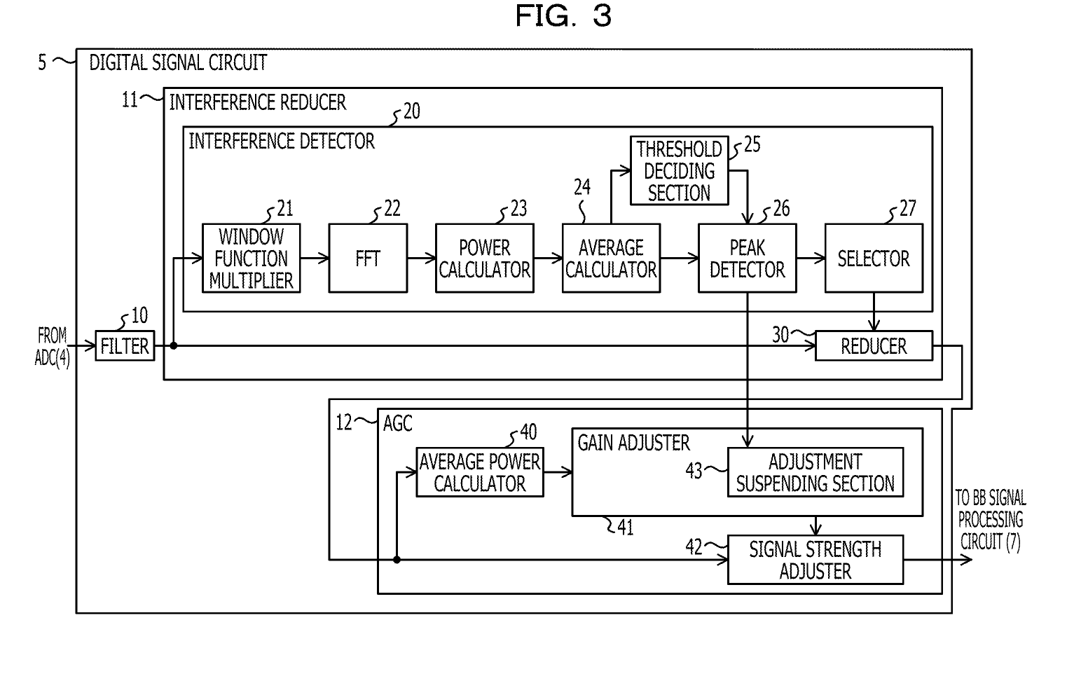

FIG. 3 depicts an exemplary a digital signal circuit. The digital signal circuit 5 includes, e.g., a filter 10, an interference reducing section 11 and an automatic gain controller 12. The automatic gain control may be indicated as “AGC”. The digital signal circuit 5 may include a component except for the depicted ones, and the same applies to other drawings such as a functional block diagram or a hardware constitution diagram.

The filter 10 filters a received digital signal provided to the digital signal circuit 5 so as to extract a signal within a receiving frequency band. The interference reducing section 11 detects an interference wave mixed into the receiving frequency band and reduces the detected interference wave. The automatic gain controller 12 adjusts a gain for a received signal, e.g., an amplifying ratio so as to adjust average power of the received signal remaining after the interference wave is reduced by the interference reducing section 11 within a preset range, and amplifies or attenuates the received signal using the adjusted amplifying ratio. The automatic gain controller 12 may adjust a gain for a received signal so as to adjust average amplitude of the received signal remaining after the interference wave is reduced by the interference reducing section 11 within a preset range.

The interference reducing section 11 includes an interference detector 20 and a reducer 30. The interference detector 20 detects an interference wave mixed into the receiving frequency band. The reducer 30 includes an interference reducing filter for reducing an interference wave from a received signal.

The interference detector 20 includes a window function multiplier 21, a fast Fourier transform section 22, a power calculator 23, an average calculator 24, a threshold deciding section 25, a peak detector 26 and a selector 27. The fast Fourier transform may be referred as “FFT”.

The window function multiplier 21 multiplies a received signal by a window function. The fast Fourier transform section 22 performs a fast Fourier transform process on the received signal multiplied by the window function so as to convert the received signal into a frequency domain signal. The power calculator 23 calculates power of every frequency component. The average calculator 24 calculates an average of the power calculated by the power calculator 23. The threshold deciding section 25 decides a threshold for detecting a power peak value based on the average power.

The peak detector 26 outputs, to the selector 27, an identification number of a frequency component whose average power calculated by the average calculator 24 exceeds the threshold calculated by the threshold deciding section 25. The peak detector 26 notifies the automatic gain controller 12 of a detected interference wave. The selector 27 selects a filter coefficient according to the identification number from the peak detector 26, and sets the filter coefficient to the interference reducing filter in the reducer 30. The automatic gain controller 12 is provided with a received signal remaining after the interference wave is reduced by the reducer 30.

The automatic gain controller 12 includes an average power calculator 40, a gain adjuster 41 and a signal strength adjuster 42. When a gain is adjusted based on average amplitude, an average amplitude calculator which calculates the average amplitude may be prepared. The average power calculator 40 calculates average power of a received signal. The gain adjuster 41 adjusts a gain for a received signal, e.g., an amplifying ratio so as to adjust average power of the received signal within a preset range. The signal strength adjuster 42 amplifies or attenuates the received signal based on the gain adjusted by the gain adjuster 41.

The gain adjuster 41 includes an adjustment suspending section 43 which suspends the gain adjuster 41 from adjustment of the gain for a received signal. Upon being notified of a detected interference wave by the peak detector 26, the adjustment suspending section 43 suspends adjustment of the gain for a received signal for a certain period of time. The period of time for which the adjustment of the gain is suspended may be called an “adjustment suspended period”.

The adjustment suspended period may be, e.g., a value estimated by the interference reducing section 11 as a time length of an interference reducing action. A statistic value decided by a statistic process based on how long the interference reducing section 11 takes to reduce interference may be used as the adjustment suspended period. The gain adjuster 41 may include an adjustment suspended period calculator which statistically calculates how long the interference reducing section 11 takes to reduce interference.

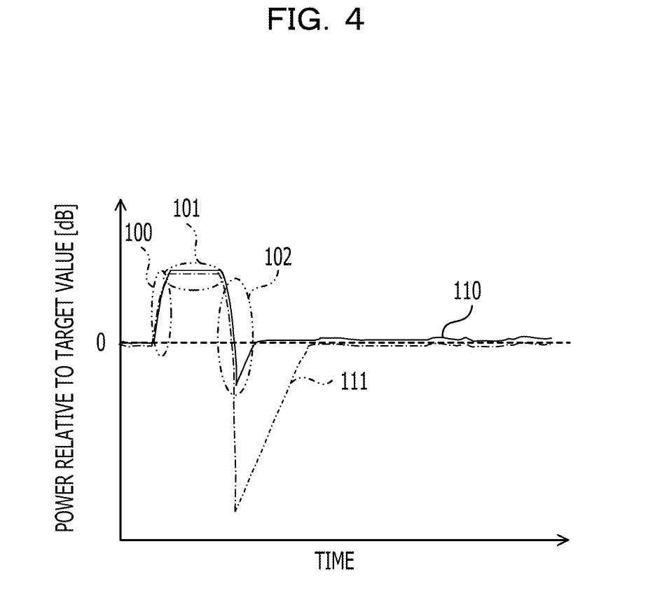

As the adjustment of the gain for the received signal is suspended for a certain period of time after an interference wave is detected, convergence time of the reducing operation on the interference may be saved. FIG. 4 depicts an exemplary received signal. A waveform corresponding to a case where the adjustment suspending section 43 suspends the adjustment of the gain is indicated by a solid line 110 in FIG. 4. A waveform corresponding to a case where the adjustment suspending section 43 does not suspend the adjustment of the gain is indicated by a dot-and-dash line 111 in FIG. 4.

A strong interference wave is mixed in a period of time 100 depicted in FIG. 4 resulting in that the power increases similarly as in FIG. 1. The gain of the received signal thereby gradually decreases according to the automatic gain control. If the peak detector 26 detects an interference wave in a period of time given a reference numeral 101, the adjustment suspending section 43 suspends reduction of the gain. Thus, a magnitude of the gain reduction is smaller than that indicated by the dot-and-dash line 111 corresponding to the case where the adjustment suspending section 43 does not suspend the adjustment of the gain. The power decrease after the gain adjustment is reduced in the period of time 102, and a period of time for gain readjustment after the interference reduction is reduced. The convergence time of a reducing operation on the interference is thereby reduced.

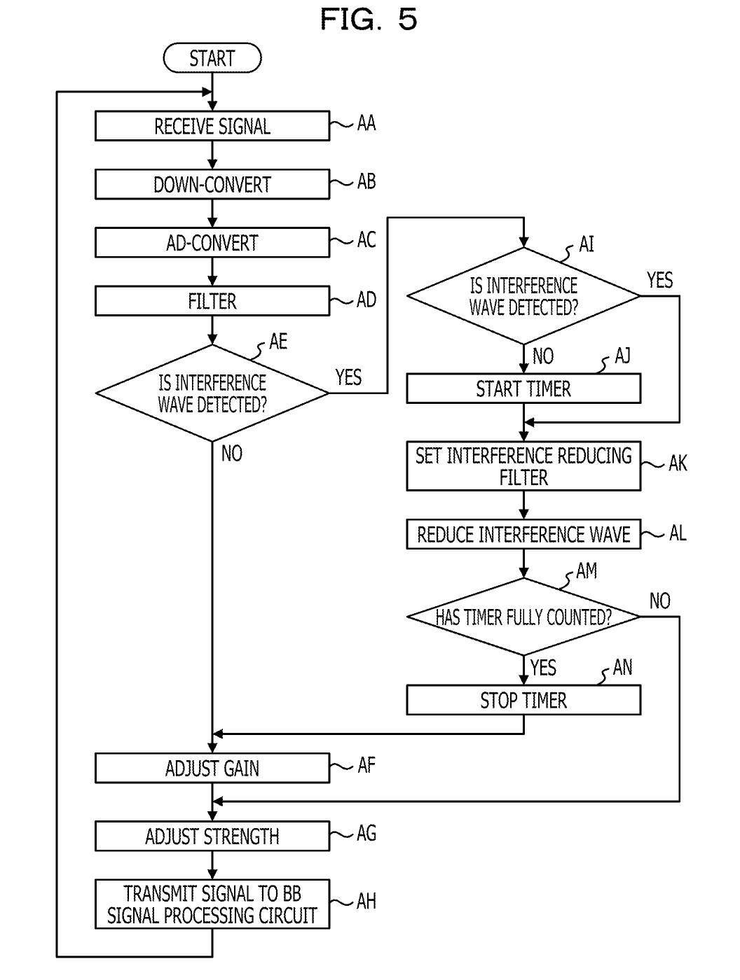

FIG. 5 depicts an exemplary process of a receiving apparatus. The process depicted in FIG. 5 may be performed by the receiving apparatus depicted in FIG. 3. Operations depicted in FIG. 5 may each include a plurality of procedures.

The receiving apparatus 1 receives a signal in an operation AA. The radio frequency circuit 3 down-converts the received radio frequency signal into an intermediate frequency signal in an operation AB. The analog-to-digital converter 4 converts the intermediate frequency signal into a digital signal in an operation AC. The filter 10 filters the received signal in a digital form so as to extract a signal within a receiving frequency band in an operation AD.

The peak detector 26 in the interference detector 20 detects presence of an interference wave in an operation AE. Unless an interference wave is detected (operation AE: N), the process proceeds to an operation AF. If an interference wave is detected (operation AE: Y), the process proceeds to an operation AI.

The gain adjuster 41 adjusts a gain for the received signal so that the value of calculated average power falls within a particular range as the operation AF. The signal strength adjuster 42 amplifies or attenuates the received signal based on the adjusted gain in an operation AG. The signal strength adjuster 42 transmits the adjusted received signal to the baseband signal processing circuit 6 in an operation AH.

The adjustment suspending section 43 in the gain adjuster 41 decides whether a timer which measures progress of the adjustment suspended period is working based on a previous detection of an interference wave in the operation AI. Unless the timer is working (operation AI: N), the process proceeds to an operation AJ. If the timer is working (operation AI: Y), the process skips the operation AJ and proceeds to an operation AK. The adjustment suspending section 43 activates the timer which measures the progress of the adjustment suspended period in the operation AJ. The process proceeds to the operation AK.

The selector 27 sets a filter coefficient to the interference reducing filter in the reducer 30 according to the identification number of the frequency on which an interference wave was detected by the peak detector 26 in the operation AK. The reducer 30 reduces the interference wave mixed into the received signal in an operation AL.

The adjustment suspending section 43 decides whether the measurement time measured by the timer runs out in an operation AM. Unless the measurement time runs out (operation AM: N), the process skips the operation AF and proceeds to the operation AG. Thus, the gain adjuster 41 suspends the gain adjustment in the adjustment suspended period. If the measurement time runs out (operation AM: Y), the process proceeds to an operation AN. The adjustment suspending section 43 stops the timer in the operation AN and the process proceeds to the operation AF. Thus, the gain adjuster 41 restarts the gain adjustment.

The gain reduction according to the automatic gain control is suspended for a certain period of time after an interference wave is detected. Unsuitable gain reduction based on an excessive signal strength detected before a completion of the reduction of the interference wave may thereby be reduced. As a period of time for readjustment of the reduced gain is saved, the convergence time of the reducing operation of the interference wave is saved.

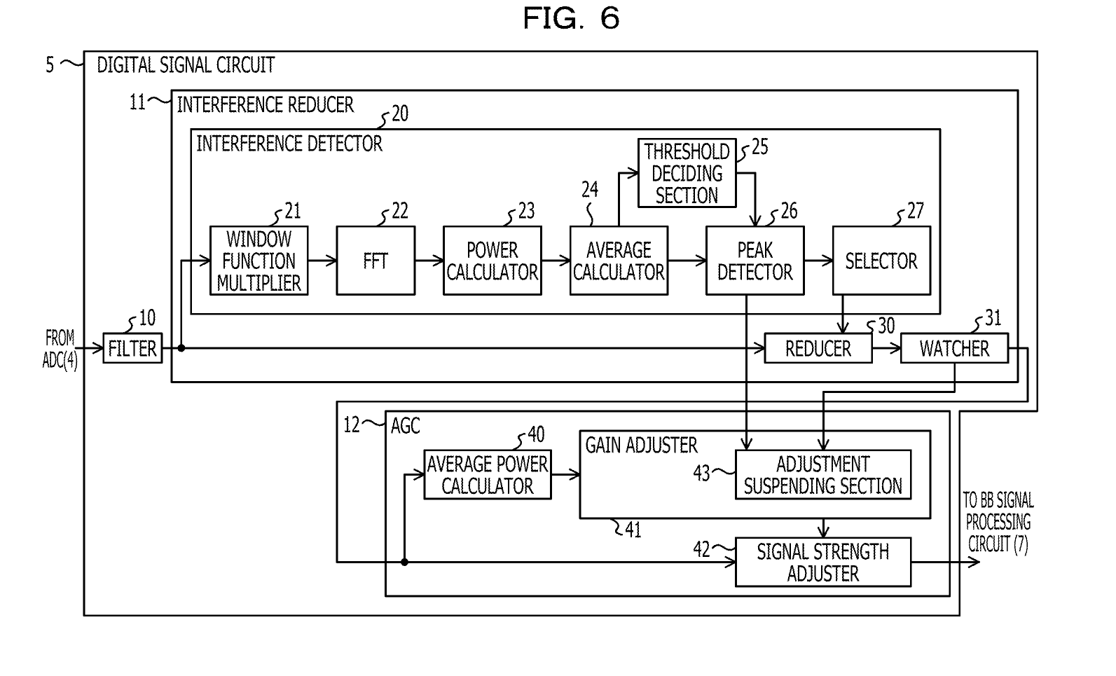

The adjustment suspending section 43 suspends the gain adjustment for the received signal by the gain adjuster 41 in the period of time after the detection of the interference wave to the completion of the reduction of the interference wave. FIG. 6 depicts an exemplary function of a digital signal circuit. A element which is the same as the corresponding one depicted in FIG. 3 is given the same reference numeral, and its explanation may be omitted or reduced.

The interference reducing section 11 has a monitor 31 which watches a received signal remaining after the reducer 30 reduces an interference wave and decides whether the interference reducing section 11 completes the reduction of the interference. The monitor 31 may decide whether the received signal provided by the reducer 30 includes an interference wave using a process which is the same as or similar to that of the interference detector 20. The watcher 31 may be, e.g., a portion of the reducer 30. The monitor 31 notifies the gain adjuster 41 of the completion of the reduction of the interference wave.

The adjustment suspending section 43 suspends the gain adjustment for the received signal after being notified of the detection of the interference wave by the peak detector 26 and before being notified of the completion of the reduction of the interference wave by the monitor 31. The adjustment suspending section 43 suspends the gain adjustment, e.g., upon being notified of the detection of the interference wave by the peak detector 26. The adjustment suspending section 43 restarts the gain adjustment, e.g., upon being notified of the completion of the reduction of the interference wave by the monitor 31.

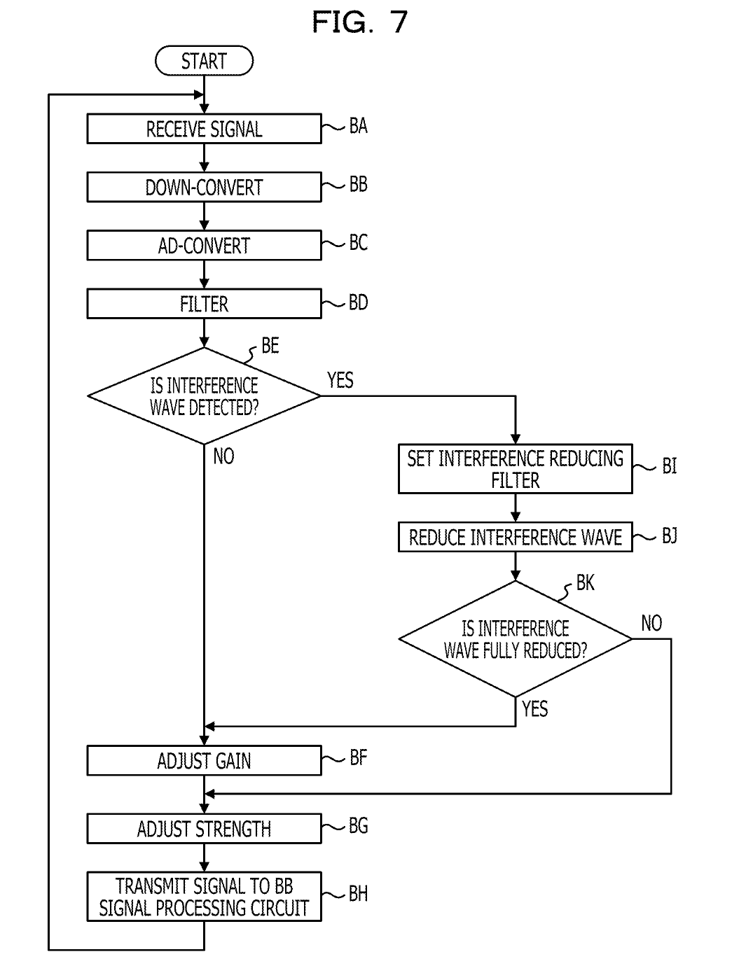

FIG. 7 depicts an exemplary process of a receiving apparatus. The process depicted in FIG. 7 may be performed by the receiving apparatus depicted in FIG. 6. The process of operations BA through BH may be substantially the same as or similar to that of the operations AA through AH depicted in FIG. 5. If an interference wave is detected (operation BE: Y), the process proceeds to an operation BI.

The selector 27 sets a filter coefficient to the interference reducing filter in the reducer 30 in the operation BI. The reducer 30 reduces an interference wave mixed into the received signal in an operation BJ. The monitor 31 decides whether the interference reducing section 11 has completed the reduction of the interference in an operation BK. Unless the reduction is not completed (operation BK: N), the process proceeds to the operation BG. The gain adjuster 41 suspends the gain adjuster 41 from the gain adjustment for the received signal after the interference wave is detected and before the reduction of interference wave is completed. If the interference is completed (operation BK: Y), the process proceeds to the operation BF. The gain adjuster 41 restarts the gain adjustment for the received signal.

If the gain adjuster 41 restarts the gain adjustment for the received signal before the interference reducing section 11 completes the reduction of the interference wave, a period of time for gain readjustment after the reduction is extended as the magnitude of the gain reduction increases. If the gain adjuster 41 delays restarting the gain adjustment later than the completion reduction of the interference wave, the completion of the gain readjustment delays by the delay time. The gin adjuster 41 may restart the gain adjustment for the received signal upon completing the reduction of the interference wave. As the delay time of the completion of gain readjustment after the interference reduction is reduced, the convergence time of the reducing operation of the interference may be saved.

The gain adjuster 41 makes a rate for a change of the gain in the automatic gain control, e.g., a time constant different for a certain period of time after completion of the reduction of the detected interference wave. The period of time for which the time constant is changed after the completion of the reduction of the interference wave may be called a “period of changed time constant”. The time constant is quicker in the period of a change period of the time constant than in another period of time.

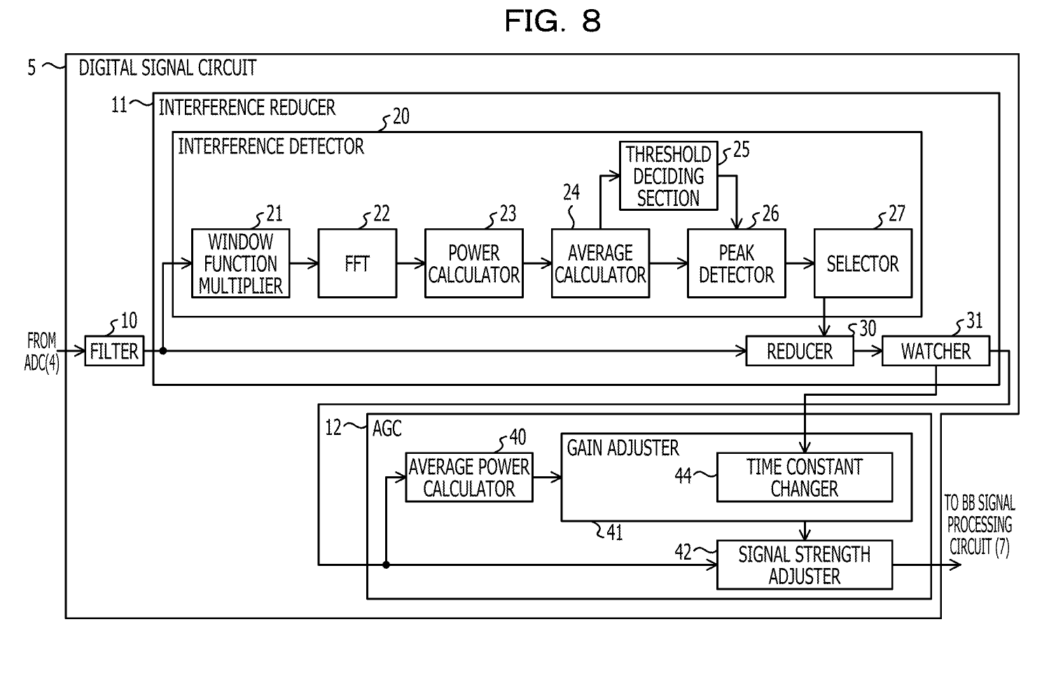

FIG. 8 depicts an exemplary digital signal circuit. A element which is the same as the corresponding one depicted in FIG. 6 is given the same reference numeral, and its explanation may be omitted or reduced. The gain adjuster 41 may include a time constant changer 44.

The gain adjuster 41 controls a gain for a received signal by changing the gain according to a certain first time constant in a period of time except for the change period of the time constant. The time constant changer 44 changes the time constant set in the automatic gain control to a second time constant which is quicker than the first time constant in the change period of the time constant.

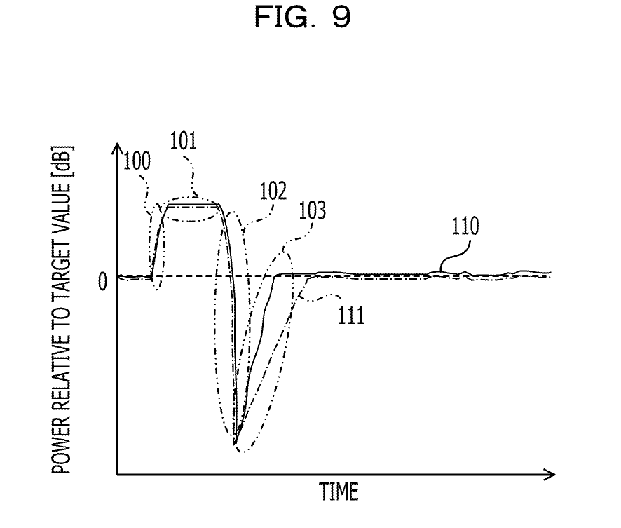

Since the automatic gain control is performed according to a quicker time constant for a certain period of time after completing the reduction of the interference wave, the convergence time of the reducing operation of the interference may be saved. FIG. 9 depicts exemplary power of a received signal. In FIG. 9, a solid line 110 indicates a waveform corresponding to a case where the time constant is changed, and a dot-and-dash line 111 indicates a waveform corresponding to a case where the time constant is not changed.

A strong interference wave is mixed in a period of time given a reference numeral 100 resulting in that the power of the received signal increases in FIG. 9, similarly as in the waveform depicted in FIG. 1. Thus, the gain for the received signal is gradually reduced according to the automatic gain control. While the gain for the received signal is reduced in a period of time 101, the waveform is clipped according to an output upper limit of the automatic gain controller 12. The power of the received signal decreases in a period of time 102 as the interference reduction continues and the interference wave is reduced.

The time constant changer 44 changes the time constant for the automatic gain control done by the gain adjuster 41 to the quicker second time constant in a period of time 103 after completing the reduction of the interference wave. Recovery time of the gain may become shorter than in a case where the time constant is not changed as indicated by the dot-and-dash line 111. The period of time for gain readjustment after the interference wave is reduced is saved, and the convergence time of the reducing operation of the interference is saved.

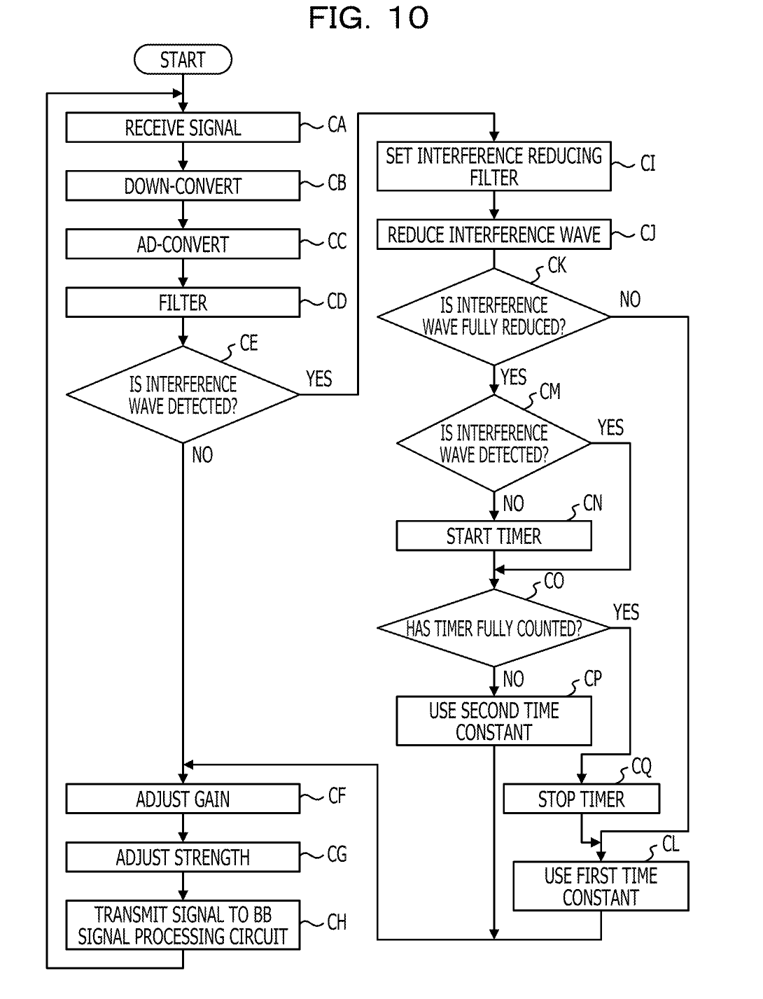

FIG. 10 depicts an exemplary process of a receiving apparatus. The process of operations CA through CH may be substantially the same as or similar to that of the operations AA through AH depicted in FIG. 5. If an interference wave is detected (operation CE: Y), the process proceeds to an operation CI.

The selector 27 sets a filter coefficient to the interference reducing filter in the reducer 30 as the operation CI. The reducer 30 reduces an interference wave mixed into the received signal as an operation CJ. The monitor 31 decides whether the interference reducing section 11 has fully reduced the interference as an operation CK. Unless the interference is fully reduced (operation CK: N), the process goes to an operation CL. If the interference is fully reduced (operation CK: Y), the process goes to an operation CM. The gain adjuster 41 uses the first time constant as the time constant for the automatic gain control as the operation CL. The gain adjuster 41 changes the gain according to the first time constant so as to adjust the gain as an operation CF. The automatic gain control is done according to the first time constant before the interference is fully reduced.

The time constant changer 44 decides whether a timer which measures the passage of the period of changed time constant is working based on the previous completion of the reduction of the interference wave in an operation CM. Unless the timer is working (operation CM: N), the process proceeds to an operation CN. If the timer is working (operation CM: Y), the process proceeds to an operation CO. The time constant changer 44 starts the timer which measures the passage of the time period for changing the time constant in the operation CN.

The time constant changer 44 decides whether the measurement time measured by the timer runs out in the operation CO. Unless the measurement time runs out (operation CO: N), the process proceeds to an operation CP. If the measurement time runs out (operation CO: Y), the process proceeds to an operation CQ. The time constant changer 44 changes the time constant for the automatic gain control by the gain adjuster 41 to the second time constant in the operation CP. The gain adjuster 41 changes the gain to the second time constant so as to adjust the gain in the operation CF. The automatic gain control is performed according to the second time constant in the period of changed time constant.

The time constant changer 44 stops the timer in the operation CQ and the process proceeds to the operation CL. After the period of changed time constant ends, the time constant for the automatic gain control returns to the first time constant.

The time constant for the automatic gain control is quickened in a certain period of time after the completion of the reduction of the interference wave. Recovery time of the automatically controlled gain after the completion of the reduction of is saved. The period of time for the gain readjustment after the completion of the reduction of is reduced and the convergence time of the reduction operation of reduce the interference is reduced. The gain adjuster 41 may combine the process for changing the time constant depicted in FIG. 8 and the process for suspending the gain adjustment depicted in FIG. 3 or FIG. 6 and may carry out the combined processes.

The time constant changer 44 makes the time constant for the automatic gain control quicker, in a period of time after the completion of the reduction of the detected interference wave and before the gain controlled by the gain adjuster 41 converges, than a time constant in another period of time. For example, the time constant changer 44 may decide that the gain control has converged when a change of the gain adjusted by the gain adjuster 41 for a certain time period falls within a particular range.

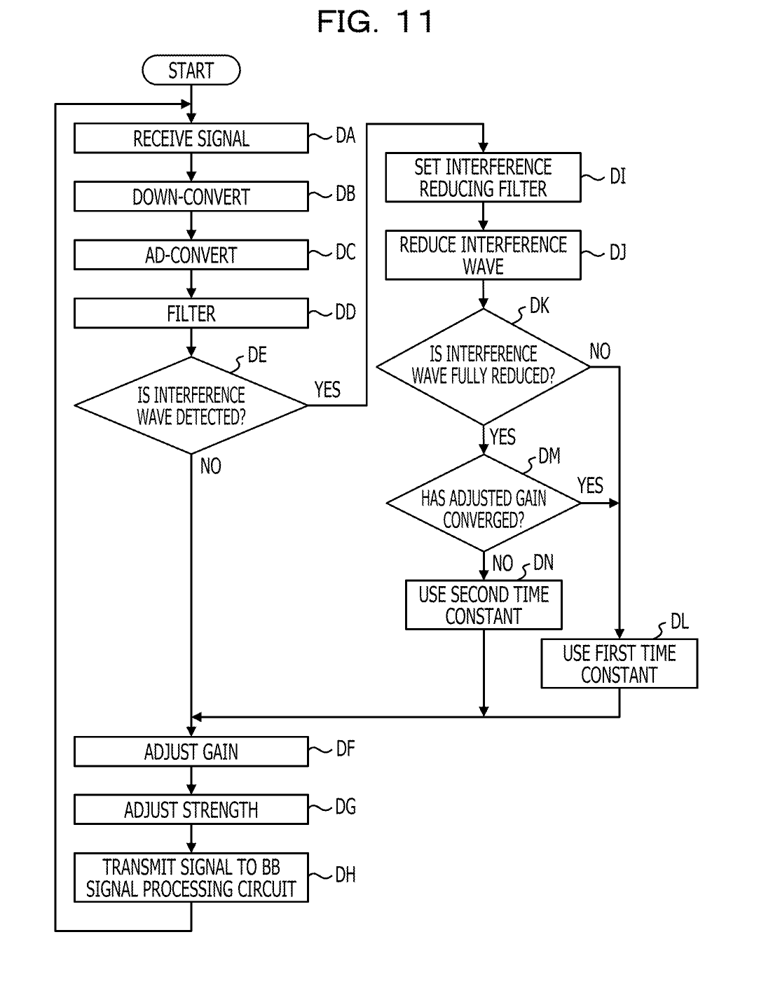

FIG. 11 depicts an exemplary process of receiving apparatus. The process of operations DA through DH may be substantially the same as or similar to that of the operations AA through AH depicted in FIG. 5. If an interference wave is detected (operation DE: Y), the process proceeds to an operation DI.

The selector 27 sets a filter coefficient to the interference reducing filter in the reducer 30 in the operation DI. The reducer 30 reduces an interference wave mixed into the received signal in an operation DJ. The monitor 31 decides whether the interference reducing section 11 completes the reduction of the interference in an operation DK. Unless the reduction of the interference completes (operation DK: N), the process proceeds to an operation DL. If the reduction of the interference completes (operation DK: Y), the process proceeds to an operation DM. The gain adjuster 41 uses the first time constant as the time constant for the automatic gain control in the operation DL. The gain adjuster 41 changes the gain to the first time constant so as to adjust the gain in an operation DF. The automatic gain control is performed by using the first time constant before the completion of the reduction of the interference.

The time constant changer 44 decides whether the gain controlled by the gain adjuster 41 has converged in the operation DM. Unless the gain control has converged (operation DM: N), the process proceeds to an operation DN. The time constant changer 44 changes the time constant for the automatic gain control by the gain adjuster 41 to the second time constant in the operation DN. The gain adjuster 41 changes the gain to the second time constant so as to adjust the gain in the operation DF. The automatic gain control is performed using the second time constant after the completion of the reduction of the interference wave and before the gain control done by the gain adjuster 41 converges.

If the gain control has converged (operation DM: Y), the process proceed to the operation DL. After the gain control converges, the time constant for the automatic gain control returns to the first time constant.

Use of a quick time constant may be avoided after the gain control by the gain adjuster 41 converges. As the period of time in which the quicker second time constant is used is set after the interference wave is detected and before the gain control converges, the affect to the receiving apparatus 1 from the change of the time constant may be reduced. The gain adjuster 41 may combine the process for changing the time constant depicted in FIG. 11 and the process for suspending the gain adjustment depicted in FIG. 5 or FIG. 7 and may carry out the combined process.

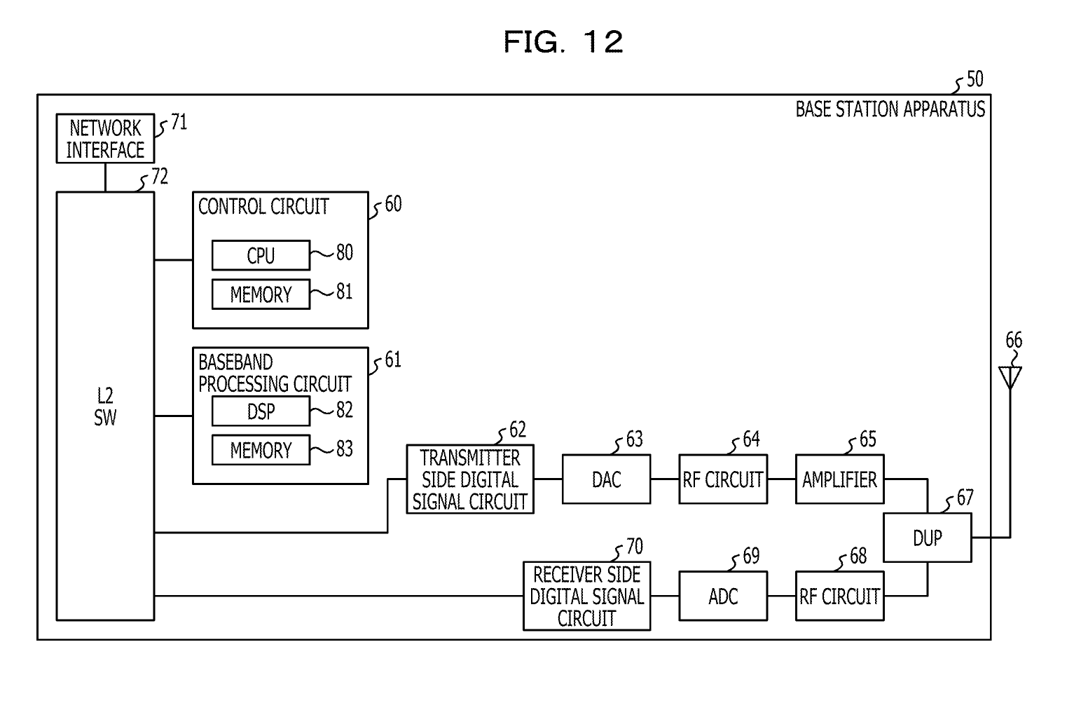

The receiving apparatus described above may be used, e.g., for a base station apparatus which receives a radio signal transmitted from a mobile station apparatus. FIG. 12 depicts an exemplary base station apparatus. FIG. 12 may depict a hardware constitution of the base station apparatus. The base station apparatus 50 includes a control circuit 60, a baseband processing circuit 61, a transmitter side digital signal circuit 62, a digital-to-analog converter 63, radio frequency circuits 64 and 68, an amplifier 65, an antenna 66 and a duplexer 67. The base station apparatus 50 includes an analog-to-digital converter 69, a receiver side digital signal circuit 70, a network interface 71 and a layer 2 switch 72. The digital-to-analog converter, the duplexer and the layer 2 switch may be referred as “DAC”, “DUP” and “L2SW”, respectively.

The control circuit 60 entirely controls the operation of the base station apparatus 50, and may include a central processing unit (CPU) 80 and a memory 81. The CPU 80 entirely controls the operation of the base station apparatus 50 by executing a computer program stored in the memory 81. The baseband processing circuit 61 performs a baseband operation on signals transmitted and received to and from a mobile station apparatus. The baseband processing circuit 61 includes a digital signal processor (DSP) 82 and a memory 83 in which a firmware program to be executed by the DSP 82 is filed.

The transmitter side digital signal circuit 62 receives, from the baseband processing circuit 61, a baseband signal to be transmitted to a mobile station apparatus. The transmitter side digital signal circuit 62 processes, e.g., filters the baseband signal in a certain manner. The digital-to-analog converter 63 converts the baseband signal provided by the transmitter side digital signal circuit 62 into an analog signal. The radio frequency circuit 64 converts the analog signal into a radio frequency signal. The radio frequency signal is amplified by the amplifier 65, and then transmitted from the antenna 66 via the duplexer 67.

A signal transmitted by a mobile station apparatus is received by the antenna 66. The received signal is provided to the radio frequency circuit 68 via the duplexer 67. The radio frequency circuit 3, the analog-to-digital converter 4 and the digital signal circuit 5 of the receiving apparatus 1 depicted in FIG. 2 may be applied to the radio frequency circuit 68, the analog-to-digital converter 69 and the receiver side digital signal circuit 70, respectively.

The network interface 71 is a communication interface circuit for communication between the base station apparatus 50 and another base station apparatus, and between the base station apparatus 50 and an upper node. The layer 2 switch 72 is coupled to the control circuit 60, the baseband processing circuit 61, the transmitter side digital signal circuit 62, the receiver side digital signal circuit 70 and the network interface 71. The layer 2 switch 72 exchanges layer 2 signals transmitted and received among those circuits.

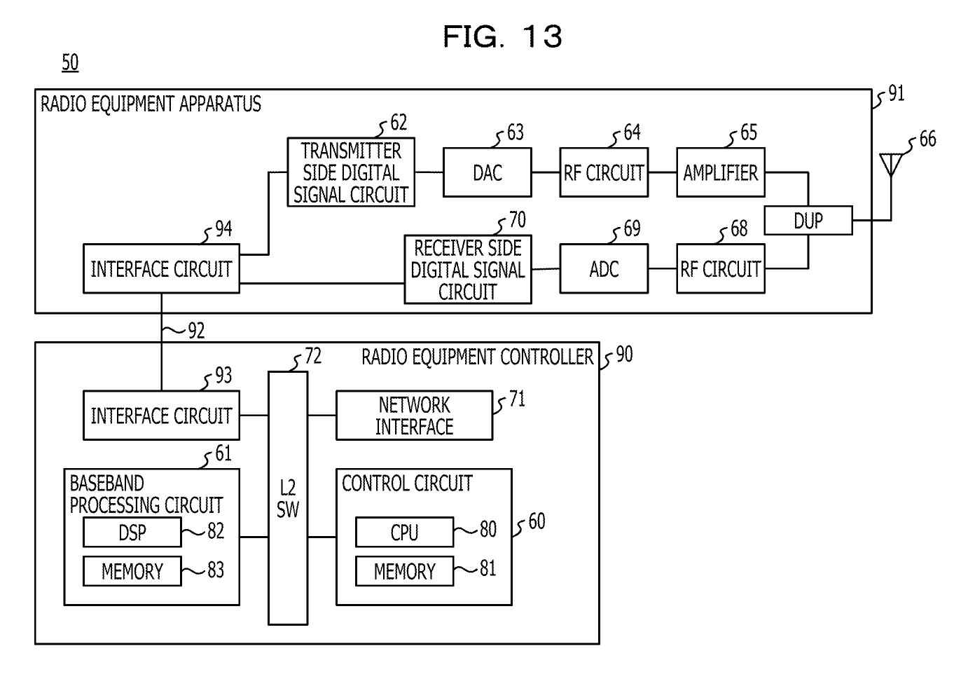

FIG. 13 depicts an exemplary base station apparatus. FIG. 13 may depict a hardware constitution of the base station apparatus 50. The base station apparatus 50 may be divided into a radio equipment controller (REC) 90 and a radio equipment (RE) apparatus 91 which are coupled with each other by a communication circuit 92. A element which is substantially the same as or similar to the corresponding one depicted in FIG. 12 is given the same reference numeral, and its explanation may be omitted or reduced.

The radio equipment controller 90 includes a control circuit 60, a baseband processing circuit 61, a network interface 71, a layer 2 switch 72 and an interface circuit 93. The radio equipment apparatus 91 includes a transmitter side digital signal circuit 62, a digital-to-analog converter 63, radio frequency circuits 64 and 68, an amplifier 65 and an antenna 66. The radio equipment apparatus 91 includes a duplexer 67, an analog-to-digital converter 69, a receiver side digital signal circuit 70 and an interface circuit 94. The radio equipment apparatus 91 may be, e.g., a remote radio head (RRH). The interface circuits 93 and 94 may transmit and receive a baseband signal on the communication circuit 92 according to standards such as the common public radio interface (CPRI) or the open base station architecture initiative (OBSAI).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A receiving apparatus comprising:
an interference wave reducer configured to reduce an interference wave included in a received signal; and
an automatic gain controller configured to automatically control a gain for the received signal, the automatic gain controller including a convergence time saver to save convergence time of an automatic gain control for the received signal based on an input of an interference wave.

2. The receiving apparatus according to claim 1, wherein the interference wave reducer includes a detector configured to detect the interference wave included in the received signal.

3. The receiving apparatus according to claim 2, wherein the convergence time saver includes a suspending section configured to suspend a change of the gain by the automatic gain controller after the detector detects the input of the interference wave.

4. The receiving apparatus according to claim 3, wherein the suspending section suspends the change of the gain for a certain period of time after the detector detects the input of the interference wave.

5. The receiving apparatus according to claim 1 further comprising, a monitor configured to detect a reduction of the interference wave by the interference wave reducer.

6. The receiving apparatus according to claim 5, wherein the convergence time saver includes a suspending section configured to suspend a change of the gain by the automatic gain controller after the input of the interference wave is detected and before the monitor detects the reduction of the interference wave.

7. The receiving apparatus according to claim 5, wherein the convergence time saver includes a rate changer configured to make a rate in a change of the gain for the received signal by the automatic gain controller quicker after the monitor detects the reduction of the interference wave.

8. The receiving apparatus according to claim 7, wherein the convergence time saver makes the rate of the change quicker in a certain period of time after the reduction of the interference wave is reduced.

9. The receiving apparatus according to claim 7, wherein the convergence time saver makes the rate of the change quicker in a period of time after the monitor detects the reduction of the interference wave and before the gain control by the automatic gain controller converges.

10. The receiving apparatus according to claim 2 further comprising, a monitor configured to detect a reduction of the interference wave by the interference wave reducer, wherein
the convergence time saver includes a rate changer configured to make a rate of a change of the gain for the received signal by the automatic gain controller quicker in a certain period of time after the monitor detects the reduction of the interference wave.

11. A base station apparatus comprising:
an interference wave reducer configured to reduce an interference wave included in a received signal; and
an automatic gain controller configured to automatically control a gain for the received signal, the automatic gain controller including a convergence time saver to save convergence time of an automatic gain control for the received signal based on an input of an interference wave.

12. A method for reducing an interference wave, the method comprising:
detecting an interference wave included in a received signal;
reducing the detected interference wave; and
saving convergence time of automatic gain control for the received signal based on an input of the interference wave.

13. The method according to claim 12 further comprising,
suspending a change of a gain for the received signal by the automatic gain control in a period of time after the input of the interference wave is detected.

14. The method according to claim 12, further comprising:
detecting a completion of the reduction of the interference wave included in the received signal; and
making a rate of a change of a gain for the received signal by the automatic gain control quicker in a certain period of time after the detection of the completion.
